(19) United States
(12) Patent Application Publication
(10) Pub. No.: US 2003/0057584 A1
(43) Pub. Date: Mar. 27, 2003

(54) Method for fabricating a ceramic based composite material

(75) Inventors: Makoto Yoshida, Higashihiroshima City (JP); Hideharu Fukunaga, Hiroshima City (JP); Gen Sasaki, Higashihiroshima City (JP); Kenya Nagahisa, Yamaguchi City (JP); Kazuya Kitatani, Higashihiroshima City (JP)

Correspondence Address: OLIFF & BERRIDGE, PLC, P.O. BOX 19928, ALEXANDRIA, VA, 22320, US

(73) Assignee: Hiroshima University, Higashihiroshima City (JP)

(21) Appl. No.: 10/163,296

(22) Filed: Jun. 7, 2002

(30) Foreign Application Priority Data
Jun. 11, 2001 (JP) 2001-175,697

(51) Int. Cl. B29C 31/00

(52) U.S. Cl. 264/85; 264/676

(57) ABSTRACT

A preform is made by bundling up fibers, and then, immersed into a ceramic slurry to form a fiber compact. Then, a tansformable ceramic material is infiltrated into voids of the fiber compact to fabricate a ceramic based fiber-reinforced composite material.

### BACKGROUND OF THE INVENTION

1. Field of the Invention

This invention relates to a method for fabricating, efficiently in a complicated shape, a fiber-reinforced type ceramic based composite material to be lightened in weight which has large heat resistance and large mechanical strength.

2. Description of the Prior Art

A fiber-reinforced type ceramic based composite material is composed of a preform made of fibers and a ceramic base to be made so as to embed the voids of the fibers, and is fabricated as follows. First of all, a one, dimensionally twisted fiber bundle or a two-dimensionally woven fabric is immersed into a solution where oxide particles are dispersed, and then, dried to form a preform. Then, the preform is set into a mold which is made of a material not to react with the preform and having large mechanical strength at higher temperature. The interior of the mold is evacuated up to a given degree of vacuum or charged with inert gas, and then, heated to a temperature where the oxide particles can be fired. Then, the preform is pressed one dimensionally or hot isostatically (HIP) under high pressure, to form the fiber-reinforced type ceramic based composite material through the firing of the oxide particles.

Therefore, the shape and the processing accuracy of the composite material depend inevitably on the processing technique due to the pressing process. As of now, it is difficult to fabricate a dense fiber-reinforced type ceramic based composite material having a three-dimensionally complicated shape. At present, a given shaped composite material is prepared through the above-mentioned pressing process, and then, post-processed by means of diamond polishing, so the fabricating cost is increased.

In this point of view, a nearnet shape forming technique for a fiber-reinforced ceramic based composite material is disclosed in Japanese Patent Application Laid-open Hei 10-259071 where a given preform is formed of inorganic reinforced fibers and ceramic powders, and set in a mold so that at least one surface of the preform is contacted with the mold and other surfaces are contacted with a pressing medium made of powders, and then, pressed via the pressing medium. In this case, since at least one surface of the preform is contacted with the mold, it may be formed flat and smooth. In this case, too, therefore, the shape of the composite material depends largely on the processing technique.

A combining method of matrix and preform is disclosed in Japanese patent Applications Laid-open Hei 2000-7452 and Hei 2000-7453 where a metal oxide melted to be constituted as a matrix is combined with a preform during one-directional solidification. With such a processing technique, the fabricating period of time of the thus obtained fiber-reinforced ceramic based composite material depends on the size of the composite material itself and the solidification speed of the metal oxide. Therefore, the fabricating period of time is elongated as the size of the composite, material is enlarged.

### SUMMERY OF THE INVENTION

It is an object of the present invention to provide a new method for fabricating in a complicated shape a dense fiber reinforced type ceramic based composite material which utilizes nearnet shape forming technique.

In order to achieve the above object, this invention relates to a method for fabricating a ceramic based fiber-reinforced composite material, comprising the steps of:

forming a preform made of fibers,

immersing the fiber perform into a ceramic slurry to form a fiber compact, and

infiltrating a transformable ceramic material into voids of the fiber compact to fabricate the ceramic based fiber-reinforced composite material.

This invention also relates to a method for fabricating a ceramic based fiber-reinforced composite material, comprising the steps of:

forming a fiber compact made of fibers, and

infiltrating a transformable ceramic material into voids of the fiber compact to fabricate the ceramic based fiber-reinforced composite material.

In the first fabricating method, a denser ceramic based fiber-reinforced composite material can be obtained due to the first and the second steps.

The transformable ceramic material may be prepared by heating a given ceramic raw material.

The inventors had intensely studied to achieve the above object and then, found out the following fact of matter. A ceramic material is heated to a given temperature to make a transformable ceramic material, which is charged in the voids of the fibers of a fiber compact (containing the fibers as reinforcing material), cooled and solidified to fabricate a fiber-reinforced ceramic based composite material in a final shape or a given shape close to the final shape. That is, a fiber-reinforced ceramic based composite material can be fabricated through nearnet shape forming technique.

In a preferred embodiment, the transformable ceramic material is melted or semi-melted to be a liquid state or a semi-liquid state,

In another preferred embodiment, the transformable ceramic material is made of oxide and/or non-oxide.

In still another preferred embodiment, the fiber compact is made of inorganic fiber or carbon fiber.

In a further preferred embodiment, the fiber compact is a sheet drawn one-dimensionally or a fabric woven two- or three-dimensionally.

In another preferred embodiment, the filtrating of the transformable ceramic material is performed under a pressurized condition utilizing e.g., HIP technique.

In still another preferred embodiment, the transformable ceramic material is made by heating a ceramic raw material to a temperature below the solidification point if the ceramic raw material is crystal state, or is made by heating a ceramic raw material to a temperature below the softening point if the ceramic raw material is glass state.

In a further preferred embodiment, the porosity of the fiber-reinforced ceramic based composite material is set to 5% or below.

### BRIEF DESCRIPTION OF THE DRAWINGS

For better understanding of the present invention, reference is made to the attached drawings, wherein

FIG. 1 is explanatory views showing a fabricating method of fiber-reinforced ceramic based composite material which is oriented one-dimensionally according to the first fabricating method of the present invention,

FIG. 2 is explanatory views showing one embodiment in a fabricating method of fiber-reinforced ceramic based composite material which is oriented three-dimensionally according to the second fabricating method of the present invention,

FIG. 3 is an equilibrium phase diagram of a ceramic raw material,

FIG. 4 is SEM photographs showing cross sections of fiber-reinforced ceramic based composite materials, which are perpendicular to the fiber directions, polished and corroded with hydrofluoric acid,

FIG. 5 another SEM photograph showing a cross section of a fiber-reinforced ceramic based composite material, which is perpendicular to the fiber direction, polished and corroded with hydrofluoric acid,

FIG. 6 is a microscope photograph showing a cross section of a fiber-reinforced ceramic based composite material, which is perpendicular to the fiber direction, polished and corroded with hydrofluoric acid,

FIG. 7 is explanatory views showing another embodiment in the second fabricating method of the present invention where a ceramic based fiber-reinforced composite material is oriented three-dimensionally according to the present invention,

FIG. 8 is explanatory view showing still another embodiment of the second fabricating method of the present invention, and

FIG. 9 is another microscope photograph showing a cross section of a fiber-reinforced ceramic based composite material, which is perpendicular to the fiber direction, polished and corroded with hydrofluoric acid.

### DESCRIPTION OF THE PREFERRED EMBODIMENTS

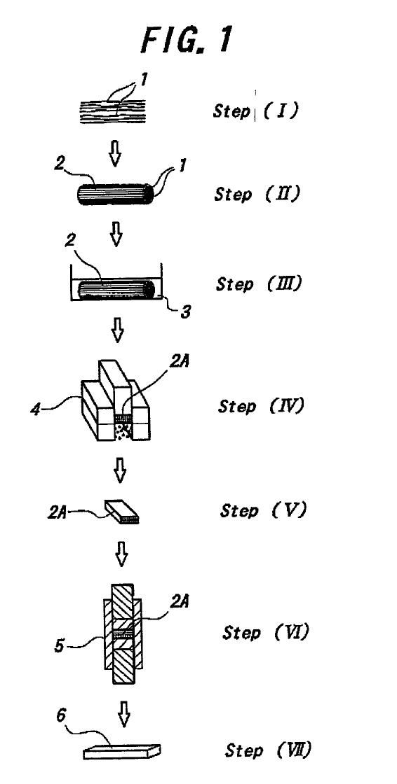

This invention will be described in detail with reference to the accompanying drawings. First of all, the first fabricating method will be described. In this embodiment, one-dimensionally oriented fiber-reinforced ceramic based composite material will be made. First of all, as shown in Steps (I) and (II) of FIG. 1, fibers 1 are bundled up to form a preform 2. Then, as shown in Step (III), the preform 2 is immersed in a slurry bath containing ceramic raw material particles. In the slurry bath, the ceramic particles and organic binder are mixed and dispersed uniformly in e.g., a distilled water. In this case, the slurry is infiltrated into the voids of the preform 2.

Then, as shown in Step (IV) of FIG. 1, the preform 2 is taken out of the slurry bath, set into and pressed by a mold 4. In this case, the excess slurry contained in the preformed 2 is removed and the preform 2 itself is formed in a near-desired shape. Then, the moisture component is removed from the preform 2 by drying at a temperature less than 100° C. to form a fiber compact 2A, as show in Step (V) of FIG. 1. If the preform 2 is dried at 100° C. or over, the moisture component is boiled and vaporized rapidly; so the preform 2 may be destroyed.

The volume of fiber in the fiber compact 2A is not restricted, but preferably set to 50% or over and less than 95%. If the fiber volume is set to 50% or over, the mechanical strength at higher temperature of the fiber compact 2A can be enhanced. If the fiber volume is set less than 95%, the shape of the fiber compact 2A can be maintained in good condition.

The sort of the fibers 1 is not restricted, but preferably made of inorganic (ceramic) fiber or carbon fiber containing carbon as main component. by 60 atomic percentages or over. Concretely, the fibers 1 is preferably made of silicon carbide fibers, carbon fibers, silicon nitride fibers or oxide fibers. Also, these kinds of fibers may be combined.

More concretely, Si—Ti—C—O fiber, Si—Zr—C—O fiber or Si—Al—C—O fiber (for example, “tyranno fiber” registered as trade mark and made by Ube industries, Ltd) may be employed. Also, Si—C—O fiber (for example, “nikaron” or “hinikaron” registered as trade mark and made by Nippon Carbon Co., Ltd.) may be employed. Moreover, SCS series fiber (made by U.S. Textron Co., Ltd) may be employed. Then, inorganic reinforced fiber substantially made of Si C, O and B which is disclosed in U.S. Pat. No. 5,366,943 may be employed. Al₂O₃ fiber which is made by U.S. Dupont Co., LID), U.S. 3M Co., LTD or Sumitomo Chemical Co., Ltd) may be employed. Also, Si—C—N fiber (for example, “HPZ fiber” under trade name made by U.S. Dow Corning Co., Ltd). Moreover, Si₃N₄ fiber made by Tonen Chemical Corporation and carbon fiber made by Tony Industries, Inc. may be employed.

The diameter of the above fiber is preferably set within 0.01-100 μm and the length of the above fiber is preferably set to 500 μm or over. If the fiber diameter is set less than 0.01 μm, the fiber may be damaged during the formation of the fiber perform, so that may not function as the reinforcing fiber. On the other hand, if the fiber diameter is set more than 100 μm, the flexibility of the fiber is deteriorated, so that it is difficult to weave the fiber three-dimensionally. Similarly, if the length of the fiber is set less than 500 μm, the gripping margin may not be created during the three-dimensional weaving of the fiber perform. The upper limited value of the length of the fiber is not restricted, and determined on the shape of the fiber perform.

Then, as shown in Step (VI) of FIG. 1, the fiber compact 2A is set in a pressure vessel 5 which is made of a material not reacted with the fiber compact 2A and then, the interior of the container 5 is heated to a given temperature where the ceramic component of the fiber compact 2A is transformable. Then, a given ceramic material is infiltrated in the fiber compact 2A. The transformability of the ceramic material is preferably defined as the viscosity thereof. For Example, the viscosity is preferably set to 10¹⁴ Pa·s Or below.

The ceramic material is preferably oxide and/or non-oxide.

If the ceramic material is made of two kinds or over of oxide such as mullite and silica, anorthite (CaO.Al₂O₃.2SiO₂), cordierite (2MgO.2Al₂O₃.5SiO₂), barium osmillite (BaO.2MgO.3A₂O₃.9SiO₂) or celsian (Ba(Si).Al₂O₃.2SiO₂)is employed, it has glass like structure after solidification.

In the case that the ceramic material has crystal structure, the ceramic material is heated at a temperature higher than the melting point. In the case that the ceramic material has glass-like structure, the ceramic material is heated to a temperature higher than the softening point, concretely a temperature where the viscosity of the ceramic material is 10¹⁴ Pa·s or below.

Then, the thus heated fiber compact 2A is pressed one dimensionally in the pressure vessel 5 to infiltrate the ceramic material into the voids of the fiber compact 2A densely by means of hot pressing or HIP.

It is desired that the infiltrating process may be carried out under inert gas atmosphere, nitrogen gas atmosphere, mixture of carbon monoxide and carbon dioxide, oxide atmosphere or the mixture of these gas components. The above pressing process may be carried out by means of mechanical pressing.

At last, the ceramic material infiltrated in the fiber compact 2A is cooled and solidified under pressurized atmosphere or non-pressurized atmosphere, to obtain a desired ceramic based fiber reinforced composite material according to the present invention, as shown in Step (VII) of FIG. 1.

In the case of the crystal ceramic material, the ceramic material is cooled down to a temperature lower than the solidification temperature, and in the case of the glass like ceramic material, the ceramic material is cooled down to a temperature lower than the softening point.

In the present invention, as mentioned above, since the melted or semi-melted ceramic material is infiltrated in the voids of the fiber compact densely through the hot pressing or the likely, the mechanical strength and the oxidation resistance of the ceramic based fiber reinforced composite material can be enhanced.

In this case, the porosity of the composite material is set to 5% or below. In this case, the mechanical strength and the oxidation resistance of the composite material can be more enhanced. For example, the composite material may be utilized as a material for a rotor blade of a gas turbine.

It is desired to provide intermediate layers functioning as slip layers between the ceramic material and the fibers. The intermediate layer is made of a normal material such as carbon, BN, monazite (lanthanum phosphor), noble all metal such as platinum or rhodium or noble metal alloy. Also, the intermediate layer may be made of multilayered structure made of carbon layer and silicon carbide layer. The intermediate layer may contain an additive easily oxidized so as to enhance the oxidization resistance thereof.

The intermediate layers are formed on the fibers, respectively prior to the infiltration of the ceramic material or during the infiltration of the ceramic material. In the latter case, the intermediate layers contain SiC, SiO₂, O₂ and C following the chemical reaction.

SiC+O₂→SiO₂+C

In the fabricating steps of FIG. 1, the melted or semi-melted ceramic material is infiltrated in the fiber compact by means of hot pressing, but may be done without the hot pressing. That is, if the ceramic material has good wettability for the fibers of the fiber compact, it can be infiltrated in the fiber compact without the pressing process. In this case, the ceramic material and the fibers are appropriately selected so as to the satisfy the good wettability, so the sorts of the ceramic material and the fibers usable under the non-pressing process are restricted. In a usual case, therefore, the ceramic material is infiltrated in the fiber compact under the pressing process to develop the selectivity in sort of the ceramic material and the fibers.

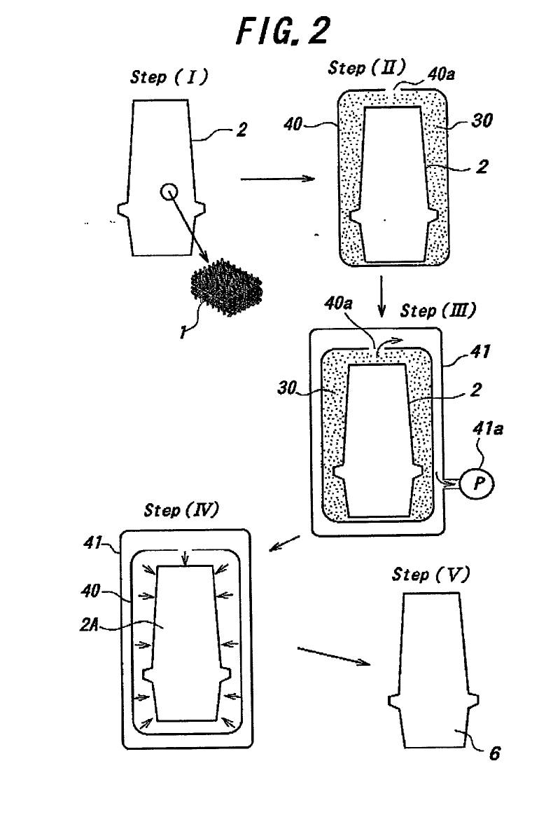

Then, the second fabricating method will be described hereinafter. In this embodiment, three-dimensionally oriented fiber-reinforced ceramic based composite material will be made, with reference to FIG. 2. First of all, as shown in Step (I) fibers 1 are woven three-dimensionally to form a fiber compact 2 which has a final product shape or a given shape close to the final shape. The perform 2 may be a plain fabric, a satin fabric, a multiaxial strained fabric or the like. Then, as shown in Step (II) of FIG. 2, the fiber compact 2 is set in a metallic capsule 40, and powdery ceramic material is charged in and fill up the space between the compact 2 and the capsule 40. The capsule 40 is made of a material such as molybdenum or platinum which is not reacted with the ceramic material and the fiber compact at an infiltrating temperature.

Then, as shown in Step (ID) of FIG. 2, the capsule 40 is set in a pressure vessel 41 of an HIP apparatus, of which the interior is evacuated to a vacuum degree of 10⁻³-10⁻¹ Pa by means of a vacuum pump 41a In this case, gas components in the ceramic material 30 and the fiber compact 2 is discharged via a hole 40a provided on the top of the capsule 40.

Then, as shown in Step (IV) of FIG. 2, the interior of the pressure vessel 41 is heated to a temperature higher than the melting point of the ceramic material 30, lid then the thus melted or semi-melted ceramic material 30 and the fiber compact 2 are isostatically pressed under an inert gas atmosphere to infiltrate the ceramic material 30 in the voids of the fiber compact 2 densely. After a given period of time elapsed under the pressurized condition, as shown in Step (V) of FIG. 2, the ceramic material 30 is cooled down and solidified to nearnet shape a desired ceramic based fiber-reinforced composite material.

In this embodiment, since the capsule 40 is employed, the ceramic material 30 can be infiltrated in the fiber compact uniformly without segregation. The capsule 40 may be made of a noble metallic foil or a glass capsule, but is not restricted only if the capsule 40 is not reacted with the ceramic material and the fiber compact.

### EXAMPLES

### Example 1

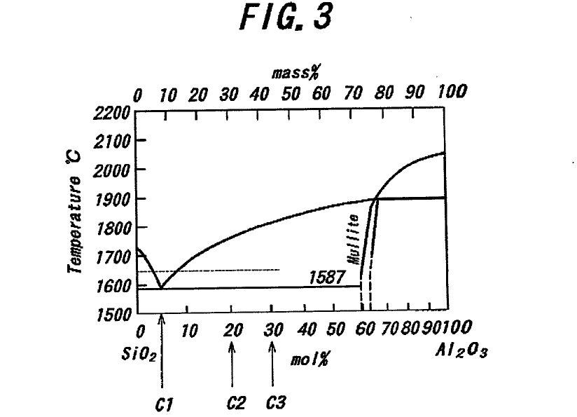

In this Example, a ceramic based fiber-reinforced composite material was fabricated according to the steps shown in FIG. 1. First of all, fired SiC fibers (“tyranno SA”: made by Ube industries, Ltd.) was prepared, and slurry 3 where ceramic material and organic binder to develop the dispensability between water and dissolved substance (“aron A-6114”: made by Toagosei Co., Ltd) were dispersed was prepared. The SiC fibers were drawn one-dimensionally to form a preform 2A. Then, the fiber perform 2A was immersed in the slurry 3 to infiltrate the ceramic material in the voids of the fiber perform 2, which was dried later to form a fiber compact 2A. Herein, as ceramic materials to be infiltrated. C1: SiO₂-3.67 mol % Al₂O₃, C2: SiO₂-20 mol % Al₂O₃, and C3: SiO₂-40 mol % Al₂O₃ were employed, on the equilibrium phase diagram shown in FIG. 3 (“J. American Soc. 70-10(1987), 750-59”, F. j. Klug, S.prochaxaka and R. H. Doremus).

Then, the fiber compact 2A was set in a dice 4 of a hot pressing apparatus, and heated at 1650° C. by means of a carbon heater under a vacuum degree of 2-3×10² Pa. In this case, the oxide component of the ceramic material was melted or semi-melted. Then, the fiber compact 2A was pressed one-dimensionally with a carbon punch under a pressure of 30 Mpa to infiltrate the above-mentioned ceramic material in the voids the fiber compact 2A densely. Under the pressurized condition, the ceramic material was cooled down at a cooling rate of 50° C./h and solidified to obtain a ceramic based fiber reinforced composite material.

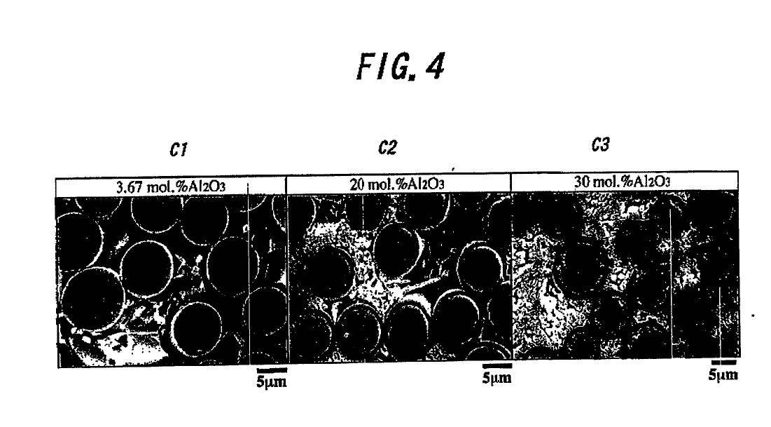

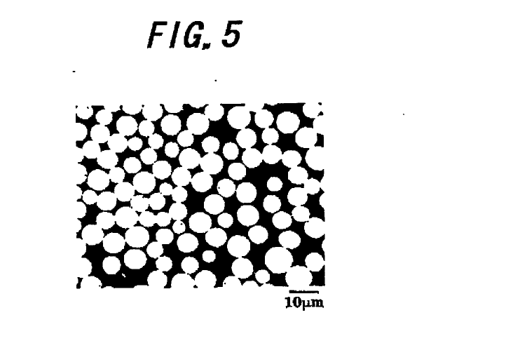

FIG. 4 is SEM photographs showing the cross sections of the thus obtained composite materials employing the C1, the C2 and the C3 ceramic materials, respectively, which are taken on surfaces perpendicular to the axes of the fibers of the composite materials. Each cross section was polished and corroded with hydrofluoric acid. As is apparent from FIG. 4, primary crystals of mullite were observed in the solidification structures of the composite materials, depending on the compositions thereof. Since the physical properties of the ceramic matrix of the composite material depend on the physical properties and the existential ratio of the primary crystal, the physical properties of the ceramic matrix can be varied if the composition of the primary crystal is appropriately selected because the physical properties of the primary crystal depends on the composition thereof to some degree. The porosities of the composite materials employing the C1, the C2 and the C3 ceramic materials were 0.1%, 0.5% and 0.7%, respectively. The solidification structures of the composite materials were dense as shown in FIG. 5.

### Example 2

In this Example, a ceramic based fiber-reinforced composite material was fabricated according to the steps shown in FIG. 2. First of all, fired SiC fibers (“tyranno Lox E”: made by Ube industries, Ltd.) was prepared, and woven three-dimensionally to form a fiber compact 2 in a rotor blade shape of gas turbine. Then, the fiber compact 2 was set in a capsule 40 made of stainless steel (SUS 304) and powdery ceramic materials (“FF201”: made by Asahi Techno Glass Co., Ltd.) of MgO.Al₂O₃.SiO₂ were charged in the space between the fiber compact 2 and the capsule 40.

The capsule 40 was disposed in a pressure vessel 41 of an HIP apparatus, and the interior of the vessel 41 was evacuated to a vacuum degree of 4×10⁻² Pa to purge gas component from the ceramic material 30 and the fiber compact 2 via a hole 40a formed at the top of the capsule 40. Then, the interior of the vessel 41 was heated to 125° C. to melt the ceramic material. In case the fiber compact 2 was covered with the melted ceramic material. Then, the fiber compact 2 was isostatically pressed in an Ax gas atmosphere under a pressure of 200 Mpa to infiltrate the ceramic material 30 in the voids of the fiber compact 2 densely. After one hour elapsed under the pressurized condition, the melted ceramic material was cooled down at a cooling rate of 500° C./h and solidified to obtain a desired ceramic based fiber-reinforced composite material.

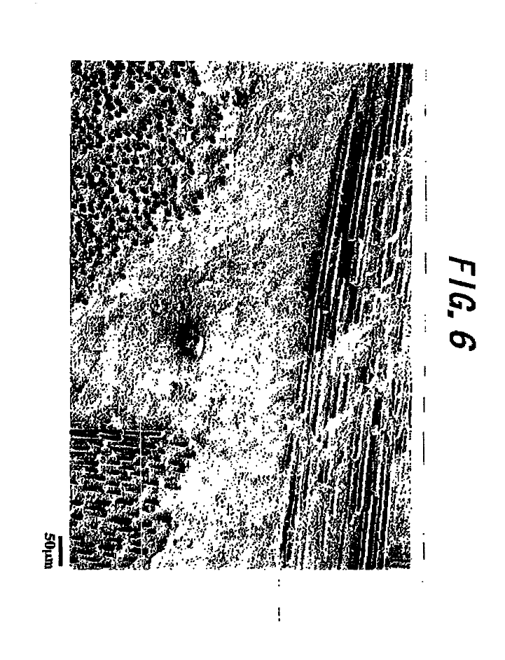

FIG. 6 is a microscope photograph showing the cross section of the fiber-reinforced ceramic based composite material, taken on a surface perpendicular to the fiber direction after polished and corroded with hydrofluoric acid. As is apparent from FIG. 6, the voids of the fiber compact 2 three-dimensionally woven were filled up with the glass-like ceramic matrix. The porosity was 0.1%.

### Example 3

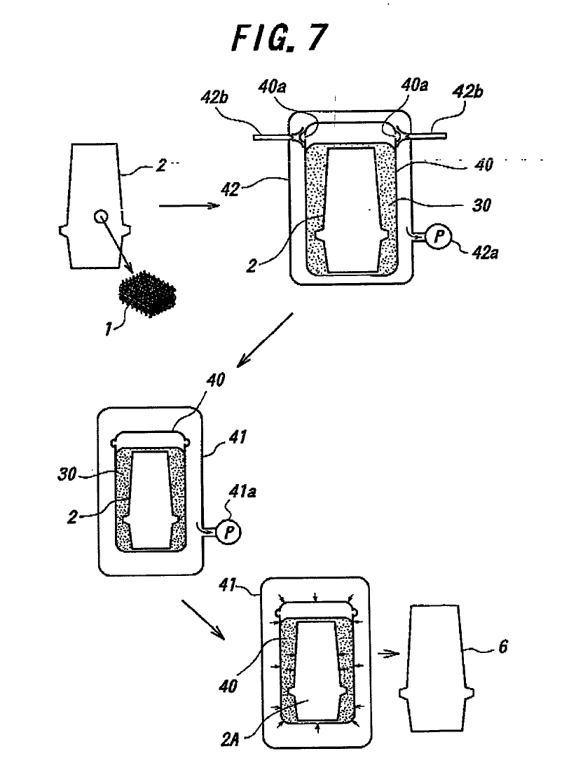

In this Example, a ceramic based fiber-reinforced composite material was fabricated according to the steps shown in FIG. 7, relating to the second fabricating method. First of all, fired SiC fibers, (“tyranno SA”: made by Ube industries, Ltd.) was prepared, and woven three-dimensionally to form a fiber compact 2 in a rotor blade shape of gas turbine. Then, the fiber compact 2 was set in a capsule 40 made of platinum and having a wall thickness of 0.3 mm and powdery ceramic materials (“MAS FF201”: made by Asahi Techno Glass Co., Ltd.) were charged in the space between the fiber compact 2 and the capsule 40.

The capsule 40 was disposed in a chamber 42 of which the interior can be evacuated to a given vacuum degree, and treated in canning. Concretely, the interior of the chamber 42 was evacuated by means of vacuum pump 42a to purge gas component in the capsule 40 via the a hole 40a. Thereafter, the capsule 40 was sealed up by welding the hole 40a of the capsule 40. In this case, the interior of the capsule 40 was maintained at a vacuum degree of 4×10⁻² Pa.

Then, the capsule 40 was disposed in a pressure vessel 41 of an HIP apparatus, and the interior of the vessel 41 was evacuated to a vacuum degree of 4×10⁻² Pa and heated to 1250° C. higher than the melting point of the ceramic material 30. In this case, the fiber compact 2 was covered with the melted ceramic material. Then, the fiber compact 2 was isostatically pressed in an Ar gas atmosphere under a pressure of 200 Mpa to infiltrate the ceramic material 30 in the voids of the fiber compact 2 densely. After one hour elapsed under the pressurized condition, the melted ceramic material was cooled down at a cooling rate of 500° C./h and solidified to obtain a desired ceramic based fiber-reinforced composite material.

### Example 4

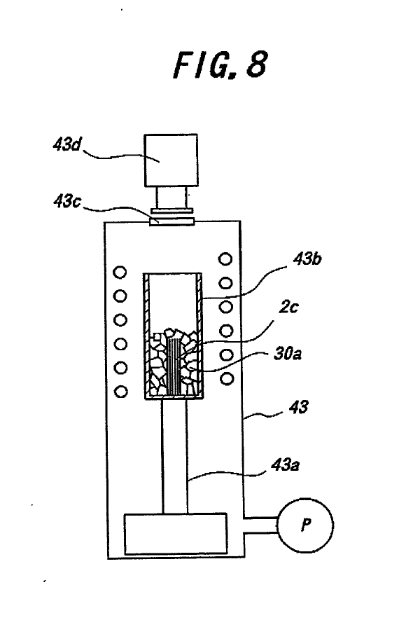

In this Example, a ceramic based fiber-reinforced composite material was fabricated according to the steps shown in FIG. 8, relating to the second fabricating method. First of all, fired SiC fibers (“tyranno SA”: made by Ube industries, Ltd.) was prepared, and drawn one-dimensionally to form a fiber compact 2. Then, the fiber compact 2 was set in a crucible 43b made of Mo and Al₂O₃-YAG eutectic oxide clusters 30a were charged around the fiber compact 2. Then, the crucible 43b was disposed in a high frequency inductive furnace 43 of which the interior was evacuated to 1 Pa. Then, the crucible 43b was heated by applying a high frequency wave to a coil 43a of the furnace 43 to melt the oxide clusters 30a indirectly. In this case, the melted oxide clusters were infiltrated in the voids of the fiber compact by themselves on the spread wetting phenomenon.

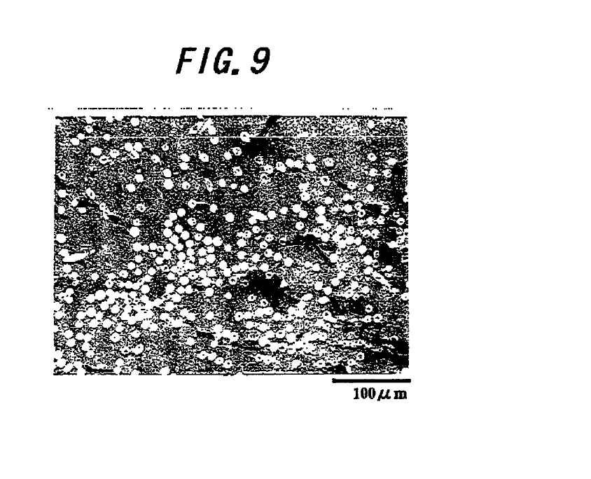

In the infiltrating process, the temperature of the oxide clusters was monitored, and the oxide clusters melted were cooled down after one minute elapsed to obtain a desired ceramic based fiber reinforced composite material when the temperature is reached to 1850° C. Thereafter, the composite material was cut out by means of diamond wheel with covered with the crucible 43b. The thus obtained cross section was polished and observed with an optical microscope as shown in FIG. 9. As is apparent from FIG. 9, the voids of the fiber compact were filled up with the oxide clusters. Therefore, it was turned out that the melted oxide clusters were infiltrated in the voids on the advanced wetting phenomenon.

According to the present invention, a new method for fabricating in a complicated shape a dense fiber reinforced type ceramic based composite material which utilizes nearnet shape forming technique can be provided. In this case, the number of fabricating step can be decreased, comparing a conventional fabricating method, so that the fabricating cost can be reduced.

Moreover, in the present invention, since a melted or semi-melted ceramic material is employed, the surfaces of fibers to be employed are not damaged during the infiltration of the ceramic material in a fiber compact, different from a conventional fabricating method.

What is claimed is:

1. A method for fabricating a ceramic based fiber-reinforced composite material, comprising the steps of:
forming a preform made of fibers,
immersing said preform into a ceramic slurry to form a fiber compact and
infiltrating a transformable ceramic material into voids of said fiber compact to fabricate said ceramic based-fiber-reinforced composite material.

2. A fabricating method as defined in claim 1, wherein said transformable ceramic material is made by heating a given ceramic raw material to a given temperature.

3. A fabricating method as defined in claim 2, further comprising the step of cooling down and solidifying said transformable ceramic material after infiltrated into said voids of said fiber compact.

4. A fabricating method as defined in claim 1, wherein said transformable ceramic material is made of at least one of oxide and non-oxide.

5. A fabricating method as defined in claim 1, wherein said fiber compact is made of inorganic fibers or carbon fibers.

6. A fabricating method as defined in claim 1, wherein said fiber compact is a sheet drawn one-dimensionally or a fabric woven two- or three-dimensionally.

7. A fabricating method as defined in claim 1, wherein said transformable ceramic material is infiltrated into said voids of said fiber compact under a pressurized condition.

8. A fabricating method as defined in claim 3, wherein said transformable ceramic material is cooled down lower than the solidification temperature if said transformable ceramic material has crystal like property.

9. A fabricating method as defined in claim 3, wherein said transformable ceramic material is cooled down lower than the melting point if said transformable ceramic material has glass like property.

10. A fabricating method as defined in claim 1, wherein the porosity of said ceramic based fiber-reinforced composite material is 5% or below.

11. A fabricating method as defined in claim 7, wherein said transformable ceramic material is infiltrated in aid voids of said fiber compact in a inert gas atmosphere, a nitrogen gas atmosphere, an oxygen gas atmosphere, or a mixture of carbon monoxide and carbon dioxide.

12. A fabricating method as defined in claim 1, further comprising the steps of forming intermediate layers between fibers and ceramic matrixes of said ceramic based fiber-reinforced composite material.

13. A method for fabricating a ceramic based fiber-reinforced composite material, comprising the steps of:
forming a fiber compact made of fibers, and
infiltrating a transformable ceramic material into voids of said fiber compact to fabricate said ceramic based fiber-reinforced composite material.

14. A fabricating method as defined in claim 13, wherein said transformable ceramic material is made by heating a given ceramic raw material to a given temperature.

15. A fabricating method as defined in claim 14, further comprising the step of cooling down and solidifying said transformable ceramic material after infiltrated into said voids of said fiber compact.

16. A fabricating method as defined in claim 13, wherein said transformable ceramic material is made of at least one of oxide and non-oxide.

17. A fabricating method as defined in claim 13, wherein said fiber Hi compact is made of inorganic fibers or carbon fibers.

18. A fabricating method as defined in claim 13, wherein said fiber compact is a sheet drawn one-dimensionally or a fabric woven two- or three-dimensionally.

19. A fabricating method as defined in claim 13, wherein said transformable ceramic material is infiltrated into said voids of said fiber compact under a pressurized condition.

20. A fabricating method as defined in claim 15, wherein said transformable ceramic material is cooled down lower than the solidification temperature if said transformable ceramic material has crystal like property.

21. A fabricating method as defined in claim 15, wherein said transformable ceramic material is cooled down lower than the melting point if said transformable ceramic material has glass like property.

22. A fabricating method as defined in claim 13, wherein the porosity of said ceramic based fiber-reinforced composite material is 5% or below.

23. A fabricating method as defined in claim 19, wherein said transformable ceramic material is infiltrated in said voids of said fiber compact in a inert gas atmosphere, a nitrogen gas atmosphere, an oxygen gas atmosphere, or a mixture of carbon monoxide and carbon dioxide.

24. A fabricating method as defined in claim 13, further comprising the steps of forming intermediate layers between fibers and ceramic matrixes of said ceramic based fiber-reinforced composite material.
